(19) United States
(12) Patent Application Publication
(10) Pub. No.: US 2004/0170749 A1
(43) Pub. Date: Sep. 2, 2004

(54) Modified starch compositions

(76) Inventors: David J. Neivandt, Bangor, ME (US); Joseph M. Genco, Orono, ME (US); Mark A. Paradis, Old Town, ME (US)

Correspondence Address: MACMILLAN SOBANSKI & TODD, LLC, ONE MARITIME PLAZA FOURTH FLOOR, 720 WATER STREET, TOLEDO, OH, 43604-1619, US

(21) Appl. No.: 10/446,745

(22) Filed: May 28, 2003

Related U.S. Application Data
(60) Provisional application No. 60/450,277, filed on Feb. 27, 2003.

(51) Int. Cl. A23G 3/00

(52) U.S. Cl. 426/658

(57) ABSTRACT

A modified starch composition is made by combining a starch with a polymer and cooking the combined starch and polymer composition under acidic conditions, the cooking producing anionic groups on the polymer. Another modified starch composition is made by cooking a starch and combining the cooked starch with a cooked polymer, the cooking producing anionic groups on the polymer, and the polymer having been cooked separately from the starch. The compositions may be used as clarifying aids for removing solids and other suspended materials from aqueous dispersions, and in particular as retention aids in the manufacture of paper.

### CROSS-REFERENCE TO RELATED APPLICATION

This application claims the benefit of U.S. provisional application serial No. 60/450,277, filed Feb. 27, 2003.

### TECHNICAL FIELD

This invention relates in general to modified starch compositions of the type suitable for use as clarifying aids for removing solids and other suspended materials from aqueous dispersions, and in particular for use as retention aids in the manufacture of paper.

### BACKGROUND OF THE INVENTION

The manufacture of paper involves forming an aqueous dispersion or “furnish” of cellulosic fibers, filler particles and potentially other materials, and then draining the furnish over a wire mesh to form a sheet. Various materials have been added to the furnish to improve retention on the sheet of the filler particles and short cellulosic fibers. For example, modified starches are frequently used for this purpose.

U.S. Pat. Nos. 5,859,128 and 6,048,929 (Moffett, R.) disclose a modified starch for use as a retention aid in a paper furnish. The modified starch is prepared by cooking, under alkaline conditions, at least one amphoteric or cationic starch with at least one polyacrylamide. U.S. Pat. No. 5,482,693 (Rushmere, J., Moffett, R.), U.S. Pat. No. 5,176,891 (Rushmere, J.) and U.S. Pat. No. 4,954,220 (Rushmere, J.) present a process for producing water-soluble polyparticulate polyaluminosilicate microgels.

U.S. Pat. No. 5,178,730 (Bixler, H., Peats, S.) discloses that an improvement in retention can be achieved by adding a medium/high molecular weight cationic polymer or by adding a natural hectorite to the furnish.

U.S. Pat. No. 4,643,801 (Johnson, K.) reveals a binder comprising a cationic starch in combination with an anionic high molecular weight polymer and a dispersed silica to improve retention. Similarly, U.S. Pat. No. 4,388,150 (Sunden, O., et al.) discloses that an improvement can be found with the use of colloidal silicic acid and cationic starch.

U.S. Pat. No. 4,066,495 (Voight, J.; Pender H.) presents a method of adding a cationic starch and an anionic polyacrylamide polymer to the pulp in a papermaking process to improve retention.

U.S. Pat. No. 5,294,301 (Kumar, et al.) discloses a process for the manufacture of paper from an aqueous pulp furnish, the improvement comprising adding to the aqueous pulp furnish at least about 0.1% based on the weight of the pulp, of at least one graft copolymer of starch, where the graft copolymer has an add-on amount of polymethacrylic or polyacrylic acid.

### SUMMARY OF THE INVENTION

This invention relates to modified starch compositions that may be used as clarifying aids for removing solids and other suspended materials from aqueous dispersions, and in particular as retention aids in the manufacture of paper. The invention also relates to methods of making the modified starch compositions.

According to this invention there is provided a modified starch composition made by combining a starch with a polymer and cooking the combined starch and polymer composition under acidic conditions, the cooking producing anionic groups on the polymer.

According to this invention there is also provided a modified starch composition made by cooking a starch and combining the cooked starch with a cooked polymer, the cooking producing anionic groups on the polymer, and the polymer having been cooked separately from the starch.

In some embodiments of the invention, the anionic groups are acid groups and/or salts of acid groups. In a particular embodiment, the polymer is polyacrylamide and the cooking produces acrylic acid groups on the polymer.

According to this invention there is also provided a method of making a modified starch composition, the method comprising combining a starch with a polymer to form a starch composition, and cooking the starch composition under acidic conditions, the cooking producing anionic groups on the polymer.

According to this invention there is also provided a method of making a modified starch composition, the method comprising cooking a starch, cooking a polymer separately from the starch, and combining the cooked starch with the cooked polymer, the cooking producing anionic groups on the polymer.

In one embodiment of the invention, the anionic groups are acid groups, and the modified starch composition has a pH greater than the pKa of the acid groups. In another embodiment, the modified starch composition has a pH lower than the pKa of the acid groups, and the method includes an additional step of raising the pH of the modified starch composition to a level greater than or equal to the pKa of the acid groups.

According to this invention there is also provided a dry mix comprising a dry mixture of starch and polyacrylamide which can be cooked under acidic, basic or neutral conditions. The dry mix can optionally include a pH adjuster and/or an aluminum compound.

### DETAILED DESCRIPTION OF THE INVENTION

A modified starch composition according to the invention is made by combining a starch with a polymer and then cooking the combined starch and polymer composition under acidic conditions. The cooking produces anionic groups on the polymer.

The starch is a cationic or amphoteric starch which may be any of those previously used in papermaking, or other suitable starches. Preferably, the starch is a cationic starch. Cationic starches may be derived from any of the common starch producing materials such as corn starch, potato starch, tapioca starch, and wheat starch. Cationization can be achieved by any suitable procedure, such as by the addition of 3-chloro-2-hydroxypropyltrimethylammonium chloride, to obtain cationic starches with various degrees of nitrogen substitution. The degree of cationic substitution on the starches (wt. % nitrogen/starch) is preferably from about 0.01 to about 0.30, and more preferably from about 0.02 to about 0.15. Naturally occurring amphoteric starches, such as potato starch, or synthetic amphoteric starches, also may be selected.

The polymer before cooking is a cationic, anionic, non-ionic or amphoteric polymer, preferably cationic. The cationic or amphoteric polymer preferably has a degree of cationic substitution from about 1 wt % to about 80 wt %. The polymer contains potential anionic groups, which are groups that can be converted into anionic groups during the cooking process. Examples of potential anionic groups include, but are not limited to, amide, ester, nitrile, acyl halide aryl halide, alkyl halide, acid halide, aldehyde, alcohol, alkylbenzene, ketone and anhydride groups. Typical examples of polymers before cooking include, but are not limited to, polyacrylamides, polyesters and polymers modified to contain groups such as those above including carboxylmethylcellulose, cellulose, starch, polydiallyldimethylammonium chloride (polyDADMAC), polyethlyimine, polyepichlorhydride and polyethyleneoxide.

The polymer after cooking includes anionic groups. Optionally, this reaction may be aided in some cases by the addition of one or more additives, such as one or more reagents (e.g., Grignard reagents). In some embodiments, the anionic groups formed during the cooking are acid groups, salts of acid groups, or combinations thereof. Examples of acidic functionalities which the polymer may contain include, but are not limited to, carboxylic, sulfuric, sulfonic phosphoric, phosphoric, phosphonic and nitric groups and salts of these groups. The polymer may be a homopolymer or a copolymer. For example, in one embodiment the polymer before cooking is polyacrylamide, and the cooking process converts a portion of the acrylamide units into acrylic acid units, resulting in a copolymer of polyacrylic acid and polyacrylamide.

The combined starch and polymer composition is cooked under acidic pH conditions (pH 6.99 or less). In some preferred embodiments, the composition is cooked at a pH from about 4.5 to about 6.5. In other embodiments, the composition is cooked at a pH from about 3 to 6.99. The preferred pH range results in optimal production of anionic groups on the polymer while minimizing starch hydrolysis.

Any suitable cooking process can be used for cooking the combined starch and polymer composition. A batch cooker or a continuous cooker, such as a jet cooker, may be used. The composition is usually cooked at a temperature above about 60° C. in an aqueous solution. Batch cooking generally is conducted at a temperature within the range of from about 60° C. to about 100° C., and preferably at atmospheric pressure. Batch cooking at greater than atmospheric pressure can be practiced, thus enabling higher cooking temperatures. Continuous cooking typically is conducted at temperatures within the range of from about 60° C. to about 130° C., and preferably at 1 atmosphere and higher pressures. Higher cooking temperatures can be used if decomposition of the starch is prevented. The cooking time will vary with the selected ingredients, cooking equipment and temperature, but typically will be within the range of less than a second to about an hour. The solids content during cooking is preferably less than about 15%, but higher solids concentrations may be used if adequate mixing can be accomplished.

The pH of the aqueous cooking solution may be adjusted with conventional acids, bases, or salts of acids or bases, such as sulfuric acid, nitric acid, hydrochloric acid, carbon dioxide producing carbonic acid, sodium carbonate, sodium bicarbonate, sodium hydroxide, and potassium hydroxide. Aluminum compounds, such alum, polyaluminum chlorides, and aluminates, such as sodium aluminate and potassium aluminate, can be used to change pH and/or can be added to provide other benefits.

If the pH of the cooked solution is greater than the pKa of the acid groups of the polymer, then the result of the process will be a gelatinous product which is ready for use as a retention aid or other intended application. Alternatively, if the pH of the cooked solution is lower than the pKa of the acid groups, then the result of the process will be a liquid which may be converted to a gel via subsequent increasing of the pH to greater than or equal to the pKa of the acid groups. The pKa of the acid groups may be considered to be the pH of the solution at and below which the acid groups are predominantly protonated. The pKa may be expressed as the negative logarithm to the base 10 of the dissociation constant Ka of the acid groups, according to the equation pKa=−log10 Ka. For example, the acrylic acid groups of polyacrylic acid generally have a pKa within a range of from about 3.5 to about 7 depending on the particular polymer.

In another embodiment of the invention, a modified starch composition is made by cooking a starch and combining the cooked starch with a cooked polymer, the polymer having been cooked separately from the starch. The cooking produces anionic groups on the polymer. The starch and the polymer can be any of those described above.

The polymer may be cooked under any pH conditions (acidic, neutral or basic) to induce the conversion of at least a portion of the potential anionic groups into acid groups, for example to convert a portion of the acrylamide groups of a polyacrylamide polymer into acrylic acid groups. The cooking process can be conducted as described above. The polymer solution resulting from this process is subsequently combined with a cooked starch solution. The starch can also be cooked under any pH conditions providing hydrolysis is avoided.

The pH of the combined polymer/starch solution may be selected to be lower than the pKa of the acid groups of the polymer, thereby facilitating mixing prior to raising the pH to a level greater than or equal to the pKa of the acid groups and inducing gelation. Alternatively, the pH of the combined polymer/starch solution may be selected to be greater than the pKa of the acrylic acid groups, thereby inducing gelation directly. The gelled product is ready for use in its intended application.

The modified starch compositions may be used in any applications for which they are suitable. Typically, they are used as clarifying aids for removing solids or other suspended materials from aqueous dispersions, and in particular as retention aids in the manufacture of paper. The modified starch compositions may be added to any suitable paper furnish to improve the retention of fines, fillers and other suspended material. The paper furnish may contain a variety of wood pulp and inorganic fillers, and typically has a pH within the range of from about 3 to about 10. Thus chemical, mechanical, chemi-mechanical and semi-chemical pulps may be used together with clays, precipitated or ground calcium carbonate, titanium dioxide, silica, talc and other inorganic fillers if desired. Such fillers typically are used at the 5% to 30% loading level, as a weight percent of the total paper weight, but may reach levels as high as 35%, or higher, for some specialty applications.

The modified starch compositions, or a paper furnish including the modified starch compositions, also may contain other typical additives, such as internal sizing agents, wet and dry strength agents, biocides, aluminum compounds (such as alum, aluminates, polyaluminum chlorides, etc.), cationic polymers (retention aids and flocculants), anionic polymers, and/or separate additions of starch. Particularly advantageous results are obtained by the addition of an anionic, cationic or amphoteric colloid, for example, montmorillonite, bentonite, silica sols, aluminum modified silica sols, aluminum silicate sols, polysilicic acid, polysilicate microgels or polyaluminosilicate microgels, separately or in combination.

The invention also relates to a dry mix comprising a dry mixture of a starch and a polyacrylamide. The dry mix may also contain a pH adjuster and/or an aluminum compound. The dry mix can be prepared, transported and stored as a dry mixture. Any suitable liquid, such as water, can be added to the dry mix to make a wet solution suitable for cooking and adding as a retention aid to a paper furnish. The dry mix can be cooked under acidic, basic or neutral conditions.

### EXAMPLES

Ash retention trials for all of the examples were conducted using furnish samples from a blend chest at a mill producing a coated wood-free grade. The furnish was comprised of 43.7% bleached hardwood kraft, 18.8% bleached softwood kraft, 12.5% coated broke and 25.0% precipitated calcium carbonate. Dosages are quoted in lb/ton fiber.

To test the ash retention performance, a drainage/retention apparatus developed by the University of Maine was used. The procedures used were similar to those described in TAPPI standard T-261.

### Example 1

This example demonstrates how cooking cationic starch and a cationic polyacrylamide together under acidic conditions yields better retention values than adding the two chemicals separately but simultaneously to a paper furnish. A blend was prepared comprised of 12 dry grams of Stalok 160 cationic starch from A. E. Staley with 120 grams of a 0.125% solution of Percol-182 cationic polyacrylamide (PAM) from Ciba Specialty Chemicals (0.15 dry grams of PAM). Next, 1868 grams of distilled water was added to the blend and the pH of the slurry was adjusted to specific levels with sodium hydroxide and hydrochloric acid. The blend was then cooked in a Sensors and Simulations auto-batch starch cooker with a warm up cycle of 20 minutes and a cooking cycle of 30 minutes at 96° C. After cooking, the sample was cooled and the pH of the cooked blend was adjusted to a level higher than the pKa of the acrylic acid groups formed using sodium hydroxide. In these experiments the adjusted pH ranged from approximately 8.4-8.5.

For purpose of comparison the Stalok 160 was prepared as a 0.6% wt solution and cooked using the same procedure as described as above. The Percol 182 was prepared by blending 1 gram of PAM and 799 grams of water under agitation for 10 minutes, and then allowing to rest for 1 hour.

For all of the experiments in this example, a 4 nm colloidal silica product from Ondeo Nalco was used and was prepared by mixing the equivalent of 1 dry gram of silica into 799 grams of water (0.125% solution). The silica dosage was 0.5 lb/ton.

For the control experiments, the starch and PAM were separately but simultaneously added to the paper furnish at a dosage of 20 lb/ton and 0.25 lb/ton respectively. The starch/PAM blends were added to the paper furnish at a rate of 20 lb/ton. The ash retention results are shown below in Table 1.

TABLE 1

| | Adjusted pH | |
|---|---|---|
| Experiment | after cooking | Ash Retention |
| Separate Addition of Starch and | | 60.1 |
| PAM (Control) | | |
| Starch and Pam cooked together at pH 4 | 8.34 | 62.1 |
| Starch and Pam cooked together at pH 5 | 8.48 | 65.3 |
| Starch and Pam cooked together at pH 6 | 8.37 | 68.9 |

The results clearly show that ash retention can be significantly improved by cooking the cationic starch and cationic PAM together under acid conditions.

### Example 2

Example 2 demonstrates that the ash retention performance of the invention can be improved by the addition of an aluminum containing compound, such as sodium aluminate, to the papermaking furnish. A starch/PAM blend was prepared by combining 12 dry grams of Stalok 160 cationic starch with 120 grams of a 0.125% solution of Percol-182 cationic polyacrylamide (0.15 dry grams of PAM). Next, 1868 grams of distilled water was added to the blend and the pH of the slurry was adjusted to 5.01 with sodium hydroxide. The blend was then cooked in the batch cooker with a warm up cycle of 20 minutes and a cooking cycle of 30 minutes at 96° C. After cooking, the sample was cooled and the pH of the cooked blend was adjusted with sodium hydroxide to a level higher than the pKa of the acrylic acid groups formed (in this experiment the final pH was 8.24).

For purpose of comparison the Stalok 160 was prepared at a 0.6% wt solution and cooked using the same procedure described above. The Percol 182 was prepared by blending 1 gram of P-182 and 799 grams of water under agitation for 10 minutes, and then allowed to rest for 1 hour.

For all of the experiments in this example, a 4 nm colloidal silica product from Ondeo Nalco was used and was prepared by mixing the equivalent of 1 dry gram of silica into 799 grams of water (0.125% solution). The silica dosage was 0.5 lb/ton.

For the control experiments, the starch and PAM were separately but simultaneously added to the paper furnish at a dosage of 20 lb/ton and 0.25 lb/ton respectively. The starch/PAM blends were added to the paper furnish at a rate of 20 lb/ton. The ash retention results are shown below in Table 2.

TABLE 2

Ash Retention

| NaALO2 Dosage, | Starch & PAM | Starch & PAM |
|---|---|---|
| lb/ton | added Separately | Cooked Together |
| 0 | 59.2 | 62.7 |
| 1 | 60.6 | 62.8 |
| 2 | 63.3 | 65.2 |

The results show that the addition of sodium aluminate to the paper furnish improves the ash retention performance. Table 2 also shows that higher ash retention is achieved when cooking the starch and PAM together, than by adding the starch and PAM separately and simultaneously.

### Example 3

Example 3 demonstrates the effect of varying the dosage of an inorganic colloid, bentonite, on ash retention when used with an acid cooked cationic starch/cationic PAM blend. A starch/PAM blend was prepared by dry blending 12 dry grams of Stalok 160 cationic starch with 0.15 grams of Percol-182 cationic polyacrylamide. Next, 1987.85 grams of distilled water was added to this the blend and the pH of the slurry was adjusted to 5.43 with sodium hydroxide. The slurry was agitated for 10 minutes then allowed to rest for 2 hours. The blend was then cooked in the batch cooker with a warm up cycle of 20 minutes and a cooking cycle of 30 minutes at 96° C. After cooking, the sample was cooled and the pH of the cooked blend was adjusted with sodium hydroxide to a level higher than the pKa of the acrylic acid groups formed (in this experiment the final pH was 7.6).

For purpose of comparison the Stalok 160 was prepared at a 0.6% wt solution and cooked using the same procedure described above. The Percol 182 was prepared by blending 1 gram of PAM and 799 grams of water under agitation for 10 minutes, and then allowed to rest for 1 hour.

The bentonite used in the experiment, Hydrocol 2D6 from Ciba Specialty Chemicals, was prepared by mixing 15 grams of bentonite powder and 235 grams of water to result in a 6% solids slurry. The dosages of bentonite ranged from 0 to 6 lb/ton.

For the control experiments, the starch and PAM were separately but simultaneously added to the paper furnish at a dosage of 20 lb/ton and 0.25 lb/ton respectively. The starch/PAM blends were added to the paper furnish at a rate of 20 lb/ton. The ash retention results are shown below in Table 3.

TABLE 3

Ash Retention

| Bentonite Dosage | Starch & PAM | Starch & PAM |
|---|---|---|
| lb/ton | added Separately | Cooked Together* |
| 0 | 56.2 | 58.3 |
| 2 | 57.4 | 60.0 |
| 4 | 59.0 | 63.7 |
| 6 | 61.7 | 65.0 |

The results show that the addition of bentonite to the paper furnish improves the ash retention performance, with the greatest performance increase seen when used with the starch/PAM blend. Table 3 again shows that higher ash retention is achieved when cooking the starch and PAM together, than by adding the starch and PAM separately and simultaneously.

### Example 4

Example 4 demonstrates the importance of the pH adjustment after acid cooking a blend of cationic starch and cationic PAM. In this example, one cationic starch/cationic PAM blend was cooked under acidic conditions below the pKa of the formed acrylic acid groups and another blend was cooked at a pH higher than the pKa of the acrylic acid groups formed. The pH of each blend was not adjusted after cooking.

A starch/PAM blend was prepared comprised of 12 dry grams of Stalok 160 cationic starch with 120 grams of a 0.125% solution of Percol-182 cationic polyacrylamide (0.15 dry grams of PAM). Next, 1868 grams of distilled water was added to the blend, and the pH of the slurry was adjusted to 4.45 with hydrochloric acid. The blend was then cooked in the batch cooker with a warm up cycle of 20 minutes and a cooking cycle of 30 minutes at 96° C. After cooking the pH of the starch/PAM blend was 4.75. A second starch/PAM blend was prepared in the same manner but with the pH of the blend adjusted to 6.54 with sodium hydroxide before cooking. The pH after cooking was measured to be 7.57.

For purpose of comparison, the Stalok 160 was prepared at a 0.6% wt solution and cooked using the same procedure described above. The Percol 182 was prepared by blending 1 gram of P-182 and 799 grams of water under agitation for 10 minutes, and then allowed to rest for 1 hour.

For the control experiments, the starch and PAM were separately but simultaneously added to the paper furnish at a dosage of 20 lb/ton and 0.25 lb/ton respectively. The starch/PAM blends were added to the paper furnish at a rate of 20 lb/ton. Colloidal silica or Bentonite micro-particles were not used in this example. The ash retention results are shown below in Table 7.

TABLE 4

| Experiment | Ash Retention |
|---|---|
| Separate Addition of Starch and PAM (Control) | 66.5 |
| Starch and PAM cooked together at pH 4.5 | 65.2 |
| Starch and PAM cooked together at pH 6.5 | 68.4 |

The table shows that the acidic cooking of a cationic starch and cationic PAM blend only results in improved retention over adding the chemicals separately to the furnish when the final pH of the cooked blend is greater than, or is adjusted to be greater than, the pKa of the acrylic acid groups of the modified PAM.

### Example 5

Example 5 demonstrates the effects of using a conventional base and an aluminum compound for pH adjustment after acidic cooking of the cationic starch/cationic PAM blend. A starch/PAM blend was prepared comprising of 12 dry grams of Stalok 160 cationic starch with 120 grams of a 0.125% solution of Percol-182 cationic polyacrylamide (0.15 dry grams of PAM). Next, 1868 grams of distilled water was added to the blend and the pH of the slurry was adjusted to 5.02 with sodium hydroxide. The blend was then cooked in the batch cooker with a warm up cycle of 20 minutes and a cooking cycle of 30 minutes at 96° C. After cooking, the starch/PAM blend was cooled and divided into two samples. The pH values of the two samples were adjusted to levels higher than the pKa of the acrylic acid groups of the PAM, one with sodium hydroxide and the other with sodium aluminate to pH values of 9.55 and 9.45, respectively.

For purpose of comparison, the Stalok 160 was prepared as a 0.6% wt solution and cooked using the same procedure described above. The Percol 182 was prepared by blending 1 gram of P-182 and 799 grams of water under agitation for 10 minutes, and then allowed to rest for 1 hour.

For the control experiments, the starch and PAM were separately but simultaneously added to the paper furnish at a dosage of 20 lb/ton and 0.25 lb/ton respectively. The starch/PAM blends were added to the paper furnish at a rate of 20 lb/ton. Colloidal silica or Bentonite micro-particles were not used in this example.

TABLE 5

| Experiment | Ash Retention |
|---|---|
| Separate Addition of Starch and PAM (Control) | 60.7 |
| Cooked Starch/PAM Blend pH adjustment with NaOH | 63.1 |
| Cooked Starch/PAM Blend pH adjustment with NaAlO2 | 62.4 |

The results shown in Table 5 indicate that using either sodium hydroxide or sodium aluminate for pH adjustment of the acidic-cooked cationic starch/cationic PAM blend results in increased ash retention over the separately added PAM and starch.

### Example 6

Example 6 demonstrates the effects of using a conventional base and an aluminum compound for pH adjustment before acidic cooking of the cationic starch/cationic PAM blend. A starch/PAM blend was prepared comprising of 12 dry grams of Stalok 160 cationic starch with 120 grams of a 0.125% solution of Percol-182 cationic polyacrylamide (0.15 dry grams of PAM). Next, 1868 grams of distilled water was added to the blend and the pH of the slurry was adjusted to 5.50 with sodium hydroxide. The blend was then cooked in the batch cooker with a warm up cycle of 20 minutes and a cooking cycle of 30 minutes at 96° C. The pH of the cooked blend was adjusted to 7.34 using sodium hydroxide.

A second starch/PAM blend was prepared as above but with the pH adjusted to 5.61 with sodium aluminate before cooking. The blend was then cooked as described above. After cooking, the starch/PAM blend was cooled and divided into two samples. The pH values of the two samples were adjusted to levels higher than the pKa of the acrylic acid groups of the modified PAM, one with sodium hydroxide and the other with sodium aluminate to pH values of 7.18 and 7.46, respectively.

For purpose of comparison, the Stalok 160 was prepared at a 0.6% wt solution and cooked using the same procedure described above. The Percol 182 was prepared by blending 1 gram of PAM and 799 grams of water under agitation for 10 minutes, and then allowed to rest for 1 hour.

For the control experiments, the starch and PAM were separately but simultaneously added to the paper furnish at a dosage of 20 lb/ton and 0.25 lb/ton respectively. The starch/PAM blends were added to the paper furnish at a rate of 20 lb/ton. Colloidal silica or Bentonite micro-particles were not used in this example.

TABLE 6

| Experiment | Ash Retention |
|---|---|
| Separate Addition of Starch and PAM (Control) | 65.4 |
| Starch/PAM Blend (NaOH before cooking/NaOH after | 69.3 |
| cooking) | |
| Starch/PAM Blend (NaAlO₂ before cooking/NaOH after | 69.7 |
| cooking) | |
| Starch/PAM Blend (NaAlO₂ before cooking/NaAlO₂ after | 69.0 |
| cooking) | |

The results shown in Table 6 indicate that using either sodium hydroxide or sodium aluminate for pH adjustment prior to cooking a cationic starch/cationic PAM blend results in increased ash retention results over the separately added PAM and starch.

### Example 7

Example 7 demonstrates that separately cooking a cationic PAM under acidic, neutral and alkaline conditions in order to create acrylic acid groups; and then adding the modified PAM to a cooked cationic starch, results in improved ash retention. The modified PAM is introduced to the starch in either of two methods. The first consists of mixing the cooked PAM and cooked starch under neutral or alkaline conditions such that the pH of the resulting mixture is greater than the pKa of the acrylic acid groups. The second method involves mixing the modified PAM and cooked starch under acidic conditions such that the pH of the mixture is below the pKa of the acrylic acid groups of the PAM. Once mixed, the pH of the blend is raised to a level higher than the pKa of the acrylic acid groups.

A cationic starch (Stalok 160) sample was prepared at 0.6% solids and cooked as described in Example 1. The cooked starch was cooled, and then divided into two samples. The pH of the first batch was adjusted to 9.05 with sodium hydroxide and the pH of the second sample was adjusted to 3.45 with hydrochloric acid.

Three samples of Percol-182 were prepared by hydrating 1.875 dry grams of PAM into 1498.125 grams of water under agitation for 10 minutes, and then allowing to rest for 1 hour. The pH of one PAM sample was adjusted with hydrochloric acid to a pH of 4.95. The remaining two PAM samples were adjusted with sodium hydroxide to pH values of 7.14 and 8.60. Each of the three PAM samples were cooked in the batch cooker as described in Example 1. After the PAM samples were cooked, they were divided into two samples for each cooking pH.

For each of the PAM cooking pH experiments, one half of the cooked sample was pH adjusted to approximately 3.5 with hydrochloric acid. The second half of the cooked PAM samples were not pH adjusted. The cooked starch/cooked PAM blends were prepared by blending 400 grams of 0.6% cooked starch and 24 grams of 0.125% cooked PAM. A total of five blends were prepared. Table 7 summarizes the prepared blends. Three of the blends were made by mixing the cooked starch with a pH of 9.05 with the cooked polyacrylamides that were not pH adjusted. Two other blends were prepared by blending the cooked starch with the pH of 3.45 and the cooked polyacrylamides with acidic pH. The blends that were mixed under acidic conditions then had their pH raised with sodium hydroxide to a level higher than the pKa of the acrylic acid groups of the PAM.

For purpose of comparison, the Percol 182 was prepared by blending 1 gram of P-182 and 799 grams of water under agitation for 10 minutes, and then allowed to rest for 1 hour.

For the control experiments, the starch and PAM were separately but simultaneously added to the paper furnish at a dosage of 20 lb/ton and 0.25 lb/ton respectively. The starch/PAM blends were added to the paper furnish at a rate of 20 lb/ton. Colloidal silica or Bentonite micro-particles were not used in this example. The ash retention results are presented in Table 8.

TABLE 7

| 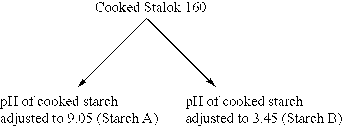 | |
|---|---|
| 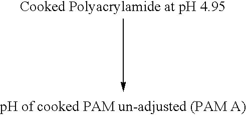 | |
| 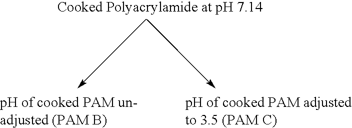 | |
| 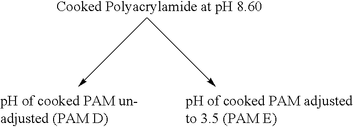 | |
| Cooked Starch/cooked | Mix of Starch A & PAM A |
| PAM Blend 1 | |
| Cooked Starch/cooked | Mix of Starch A & PAM B |
| PAM Blend 2 | |
| Cooked Starch/cooked | Mix of Starch A & PAM D |
| PAM Blend 3 | |
| Cooked Starch/cooked | Mix of Starch B & PAM C; |
| PAM Blend 4 | pH of mix increased to 8.5 |
| Cooked Starch/cooked | Mix of Starch B & PAM E; |
| PAM Blend 5 | pH of mix increased to 8.5 |

TABLE 8

| Experiment | Ash Retention |
|---|---|
| day 1 | |
| Separate Addition of Starch and PAM (Control) | 60.6 |
| Blend 1 | 62.6 |
| day 2 | |
| Separate Addition of Starch and PAM (Control) | 62.4 |
| Blend 2 | 64.6 |
| Blend 4 | 64.0 |
| Blend 3 | 67.9 |
| Blend 5 | 68.2 |

The results presented in Table 8 show that increased retention over the separate addition of starch and PAM can be achieved by mixing cooked starch and acid, alkaline or neutral cooked PAM under either acidic or alkaline conditions.

### Example 8

Example 8 demonstrates that cooking starch/PAM slurries prepared from a dry mix product comprised of cationic starch, cationic polyacrylamide and potentially various dry acidic or basic species yields better retention values than adding the two chemicals separately but simultaneously to a paper furnish. The starch/PAM blends were cooked under acidic, neutral and alkaline conditions. This example also demonstrates that the starch/PAM blends can be cooked at higher temperatures such as those used in industrial conditions.

In the first series of experiments two starch/PAM dry mixtures were prepared by mixing for each, 60 dry grams of Stalok 160 and 0.75 grams of PAM. To one of the dry mixtures, 0.5 grams of sodium carbonate was added to adjust the pH. A 60 dry gram sample of Stalok 160 was also measured for the control. The three dry mixtures were each hydrated in enough distilled water to equal 6% solids. The slurries were mixed for 10 minutes, then allowed to rest for 2 hours. The pH of the starch/PAM blend and the starch/PAM/Na₂CO₃ blend were 4.09 and 9.09 respectively. The control starch and the two blends were then cooked in a bench top jet-cooker at 120° C. After cooking the pH of the acidic blend was adjusted to 7.61 using sodium aluminate. The pH of the alkaline blend was 8.96 after cooking with no additional pH adjustment made.

For the second series of experiments, two starch/PAM dry mixtures were prepared by mixing for each, 12 dry grams of Stalok 160 and 0.15 grams of PAM. To one of the dry mixtures, 0.04 grams of sodium bicarbonate was added to adjust the pH, to the second mixture 0.025 g of sodium carbonate was added. A 12 dry gram sample of Stalok 160 was also measured for the control. The three dry mixtures were each hydrated in enough distilled water to equal 0.6% solids. The slurries were mixed for 10 minutes, then allowed to rest for 2 hours. The pH of the starch/PAM/NaHCO₃ blend and the starch/PAM/Na₂CO₃ blend were 6.45 and 6.87 respectively. The three slurries were then cooked in a Sensors and Simulations auto-batch starch cooker with a warm up cycle of 20 minutes and a cooking cycle of 30 minutes at 96° C. After cooking the pH of the starch/PAM/NaHCO₃ blend and the starch/PAM/Na₂CO₃ were 7.23 and 7.41 respectively. For the control, Percol 182 was prepared by blending 1 gram of P-1 82 and 799 grams of water under agitation for 10 minutes, and then allowed to rest for 1 hour.

For the control experiments, the starch and PAM were separately but simultaneously added to the paper furnish at a dosage of 20 lb/ton and 0.25 lb/ton respectively. The starch/PAM blends were added to the paper furnish at a rate of 20 lb/ton. Colloidal silica or Bentonite micro-particles were not used in this example. The ash retention results are shown below in Table 9.

TABLE 9

| Experiment | Ash Retention |
|---|---|
| day 1 (jet cooked) | |
| Separate Addition of Starch and PAM (Control) | 57.5 |
| Starch/PAM blend | 62.5 |
| Starch/PAM/Na₂CO₃ blend | 62.4 |
| day 2 (batch cooked) | |
| Separate Addition of Starch and PAM (Control) | 67.0 |
| Starch/PAM/NaHCO₃ blend | 70.4 |
| Starch/PAM/Na₂CO₃ blend | 70.8 |

The results shown in Table 9 indicate that cooking a cationic starch/cationic PAM blend prepared from various dry mixtures result in increased ash retention over the separately added PAM and starch. The results suggest that the starch/PAM blend can be successfully prepared at various pH values, cooking temperatures and with various dry pH control additives.

1. A modified starch composition made by combining a starch with a polymer and cooking the combined starch and polymer composition under acidic conditions, the cooking producing anionic groups on the polymer.

2. A modified starch composition according to claim 1 wherein the anionic groups are selected from the group consisting of acid groups, salts of acid groups, and combinations thereof.

3. A modified starch composition according to claim 2 wherein the polymer before cooking is cationic, anionic, amphoteric or non-ionic polyacrylamide, and wherein the cooking produces acrylic acid groups on the polymer.

4. A modified starch composition according to claim 1 further including an aluminum compound combined with the starch composition prior to cooking the starch composition.

5. A furnish including the modified starch composition of claim 1.

6. A furnish according to claim 5 further including an inorganic and/or organic colloid.

7. A furnish according to claim 5 further including an aluminum compound.

8. A modified starch composition made by cooking a starch and combining the cooked starch with a cooked polymer, the cooking producing anionic groups on the polymer, and the polymer having been cooked separately from the starch.

9. A modified starch composition according to claim 8 wherein the anionic groups are selected from the group consisting of acid groups, salts of acid groups, and combinations thereof.

10. A modified starch composition according to claim 9 wherein the polymer before cooking is cationic, anionic, amphoteric or non-ionic polyacrylamide, and wherein the cooking produces acrylic acid groups on the polymer.

11. A modified starch composition according to claim 8 further including an aluminum compound combined with the starch prior to cooking the starch.

12. A furnish including the modified starch composition of claim 8.

13. A furnish according to claim 12 further including an inorganic and/or organic colloid.

14. A furnish according to claim 12 further including an aluminum compound.

15. A method of making a modified starch composition, the method comprising combining a starch with a polymer to form a starch composition, and cooking the starch composition under acidic conditions, the cooking producing anionic groups on the polymer.

16. A method according to claim 15 wherein the anionic groups are acid groups, wherein the modified starch composition has a pH lower than the pKa of the acid groups, and wherein the method comprises an additional step of raising the pH of the modified starch composition to a level greater than or equal to the pKa of the acid groups.

17. A method according to claim 15 wherein the anionic groups are acid groups, and wherein the modified starch composition has a pH greater than the pKa of the acid groups.

18. A method according to claim 15 comprising an additional step of combining an aluminum compound with the starch composition prior to cooking the starch composition.

19. A method of making a modified starch composition, the method comprising cooking a starch, cooking a polymer separately from the starch, and combining the cooked starch with the cooked polymer, the cooking producing anionic groups on the polymer.

20. A method according to claim 19 wherein the anionic groups are acid groups, wherein the modified starch composition has a pH lower than the pKa of the acid groups, and wherein the method comprises an additional step of raising the pH of the modified starch composition to a level greater than or equal to the pKa of the acid groups.

21. A method according to claim 19 wherein the anionic groups are acid groups, and wherein the modified starch composition has a pH greater than the pKa of the acid groups.

22. A method according to claim 19 comprising an additional step of combining an aluminum compound with the starch prior to cooking the starch.

23. A dry mix comprising a dry mixture of starch and polyacrylamide which can be cooked under acidic, basic or neutral conditions.

24. A dry mix according to claim 23 further including a pH adjuster.

25. A dry mix according to claim 23 further including an aluminum compound.
